(19) United States
(12) Patent Application Publication
(10) Pub. No.: US 2024/0051453 A1
(43) Pub. Date: Feb. 15, 2024

(54) A LOAD RESTRAINT BAR

(71) Applicant: FERNHAY PARTNERS LIMITED, Newbury Berkshire (GB)

(72) Inventor: Robin Paul Haycock, Newbury Berkshire (GB)

(21) Appl. No.: 18/259,086

(22) PCT Filed: Dec. 23, 2021
(86) PCT No.: PCT/GB2021/053428

§ 371 Date: Jun. 23, 2023

(30) Foreign Application Priority Data
Dec. 23, 2020 (GB) 2020556.3

(51) Int. Cl. B60P 7/15; B60P 7/13

(52) U.S. Cl. CPC B60P 7/15; B60P 7/13

(57) ABSTRACT

A system for restraining intermodular cargo being transported in a hold of vehicle. The system comprises a load restraint bar arranged to extend between, and clamp against, parallel supporting surfaces such as provided by shelving arranged on either side of the hold. The load restraint bar includes longitudinal extending projections about which the load restraint bar seats on and can slide along the shelving to position the restraint 10 member against the cargo. The load restraint bar also including a projection that extends over or against the cargo to constrain vertical movement of the cargo away from the floor of the hold.

### CROSS-REFERENCE TO RELATED APPLICATIONS

This application claims priority from and is related to the following prior application Patent Cooperation Treaty Patent PCT/GB2021/053428, filed on 23 Dec. 2021, which claims priority to Great Britain Patent Application No. 2020556.3, filed on 23 Dec. 2020. These prior applications, including the entirety of their written description and drawings, are collectively hereby incorporated by reference into the present application.

### BACKGROUND

The present invention relates to constraining cargo within cargo containers and delivery vehicles.

FIG. 1 illustrates the interior of a delivery van adapted to courier freight from a hub to individual addresses, known as ‘last mile delivery’.

The vehicle is fitted out with shelving 1 that extends on either side from front to back to hold parcels and other items for delivery. A central portion of the vehicle deck (also referred to as the floor or base) between the shelving provides a walkway 2 to give access to the shelving. This arrangement allows a delivery person to quickly access parcels during the delivery round. However, the provision of the walkway 2 reduces the total volume available within the van for storing cargo, and thus underutilizes the capacity of the vehicle.

### BRIEF SUMMARY

A solution (which is not admitted as prior art) is to load intermodal cargo containers into the walkway 2 following the initial loading of the shelves 1 with parcels at the beginning of a delivery round. The delivery van then delivers the intermodal cargo units (favorably as one of the first stops on the delivery route) to a local drop off (hub) where they are transferred off the van onto smaller delivery vehicles, such as an electric freight bike or powered walker from which the cargo within said containers can be delivered in parallel with the parcels in the van.

The present invention was conceived to provide means for constraining cargo such as the aforementioned intermodal containers within the walkway during transit.

According to a first aspect of the invention there is provided a system comprising: a pair of elongate supports extending parallel about opposite sides of a deck of a vehicle to constrain movement of cargo placed on the deck between the supports in a horizontal plane; each support having an upward facing surface and an inward facing surface, the inward facing surfaces orientated face-to-face across the deck; and a rigid elongate load restraint tool that extends between and is secured to the supports to constrain movement of cargo placed on the deck between the supports, the restraint member comprising: an end face about either end of the restraint tool that faces the inward facing surface of its respective support; a projection that protrudes longitudinally beyond each end face about which the restraint tool seats on and can slide along the upward facing surfaces of the support to position the restraint tool against the cargo; and a clamp having a jaw that defines, at least in part, one of the end faces; the clamp operable to move the jaw about a longitudinal axis of the restraint tool to press the end faces against the inward facing surfaces of the support to secure the tool in position against the supports.

The projections allow the restraint bar to slide along the supports into position against the cargo before being secured by the clamp.

The restraint member may comprise further projections that, when the restraint member is seated against the cargo, mechanically constrain movement of the cargo about a vertical axis. The further projections may extend directly above the cargo. The projections may be upwardly extending. The further projections may be wedge shaped or otherwise tapered. The cargo may comprise a container; a side of the container may comprise a recess for receiving one of the further projections. The recess may narrow from its opening.

The restraint member may comprise a beam, and a spring, the clamp is mounted to the beam about a connection that allows the clamp to move (e.g. slide) relative to the beam about the longitudinal axis of the restraint member against the spring when the clamp is actuated to press the jaw against the support.

The restraint member may comprise a further projection that protrudes longitudinally beyond each end face, the further projection offset so as to lie directly underneath the support to mechanically constrain the load in a vertical plane.

At least one of the further projections may be provided by a lip of the jaw of the clamp. This avoids the need to provide the beam at the end where the clamp is present with a further projection making it maneuver the member into position on top of the supports as the jaw can be arranged in a retracted position at this time.

According to another aspect of the invention there is provided a restraint member of the system variously described above.

The restraint member may include a beam formed of a rigid sheet material, e.g. a metal such as aluminium or steel. The sheet may be bent to define, at least in part, one or more of the projections and/or further projections.

The restraint member may comprise projections that, when the restraint member is seated against the cargo, extend directly above the cargo to mechanically constrain movement of the cargo about a vertical axis.

The restraint member may comprise a beam, and a spring, the clamp is mounted to the beam about a connection that allows the clamp to move relative to the slide about the longitudinal axis of the restraint member against a spring when the clamp is actuated to press the jaw against the support.

The restraint member may comprise a further projection that protrudes longitudinally beyond each end face, the further projection being offset so as to lie directly underneath the support to mechanically constrain the load in a vertical plane.

The projections may lie and/or extend laterally outwards from a central external side of the beam to provide orientational stability whilst the restraint member is being slid across the supports.

The cargo may comprise an intermodal container.

### BRIEF DESCRIPTION OF THE DRAWINGS

The accompanying figures in which like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a perspective rearward view of the interior of a delivery van;

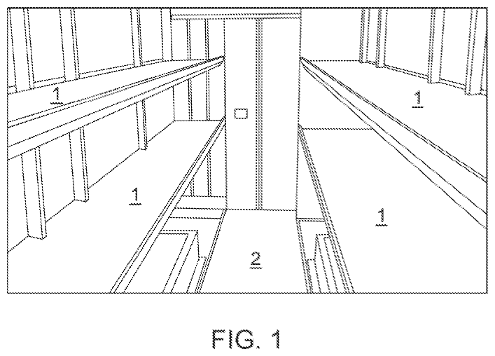

FIG. 2A is a perspective view of a load restraint member viewed from a first end;

FIG. 2B is a perspective view of the load restraint member viewed from a second end;

FIG. 3A is a side elevation of the restraint member being mounted between two parallel shelves;

FIG. 3B is a perspective view of the restraint member being mounted between two parallel shelves;

FIG. 4 is a plan view of the restraint member mounted on the shelves before being slid into its final position;

FIG. 5A is a plan view of the restraint member mounted on the shelves in its final position against an intermodal container;

FIG. 5B is a perspective view of the restraint member mounted on the shelves in its final position against an intermodal container;

FIG. 6A is a side elevation of the restraint member mounted in its final position before the clamp is actuated;

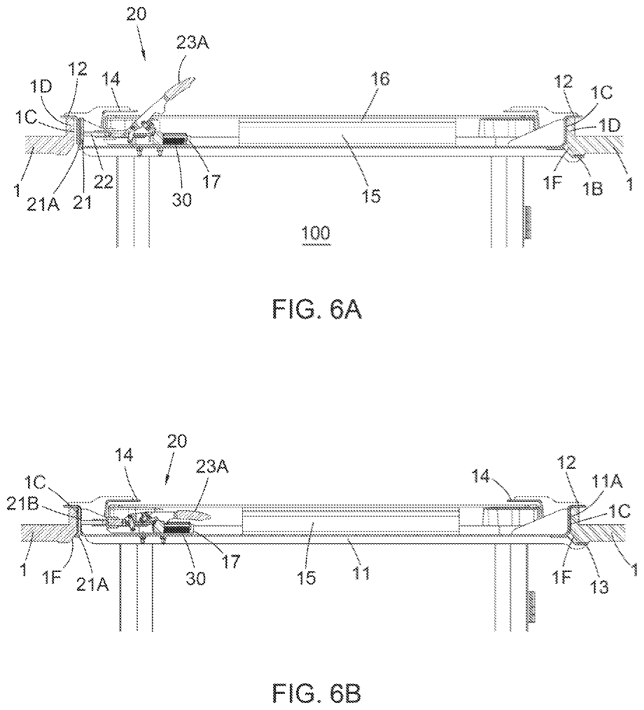

FIG. 6B is a side elevation of the restraint member mounted in its final position with the clamp actuated;

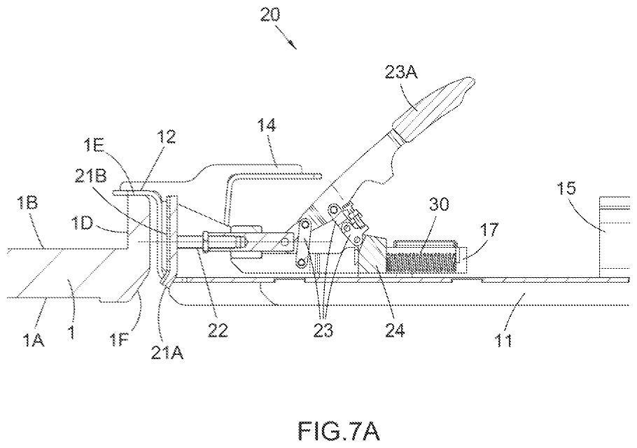

FIGS. 7A and 7B are side elevations close ups of the second end of the restraint member corresponding to FIGS. 5A and 5B to show the clamp element in greater detail; and

FIG. 8 is a perspective view of a variant load restraint member.

FIGS. 9A and 9B are perspective views of an example container suitable for use with various embodiments of the invention.

### DETAILED DESCRIPTION

As required, detailed embodiments are disclosed herein; however, it is to be understood that the disclosed embodiments are merely examples and that the devices and methods described herein can be embodied in various forms. Therefore, specific structural and functional details disclosed herein are not to be interpreted as limiting, but merely as a basis for the claims and as a representative basis for teaching one of ordinary skill in the art to variously employ the disclosed subject matter in virtually any appropriately detailed structure and function. Further, the terms and phrases used herein are not intended to be limiting, but rather, to provide an understandable description. Additionally, unless otherwise specifically expressed or clearly understood from the context of use, a term as used herein describes the singular and/or the plural of that term.

The terms “a” or “an”, as used herein, are defined as one or more than one. The term “plurality”, as used herein, is defined as two or more than two. The term “another”, as used herein, is defined as at least a second or more. The terms “including” and “having,” as used herein, are defined as comprising i.e., open language. The term “coupled,” as used herein, is defined as “connected,” although not necessarily directly, and not necessarily mechanically.

It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

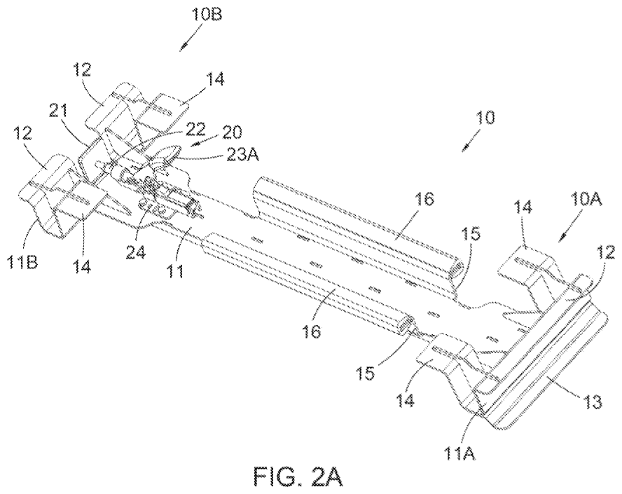

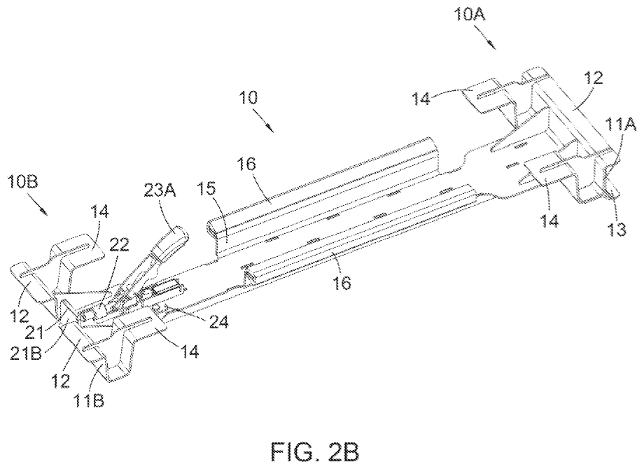

FIGS. 2A and 2B illustrates a load restraint member 10 adapted to extend between parallel supports such as shelves 1 or rails. The restraint member 10 comprises a rigid elongate beam 11 having longitudinally facing ends faces 11A 11B. Provided at each end are one or more upper outer flanges 12 which project longitudinally outwards beyond the end faces 11A 11B. Provided about a first end 10A of the restraint member 10 is a lower flange 13 that projects longitudinally outwards beyond the end face 11A of the first end 10A. Each end 10A 10B also comprises upper inward flanges 14 that project longitudinally inward from the respective end faces 11A 11B.

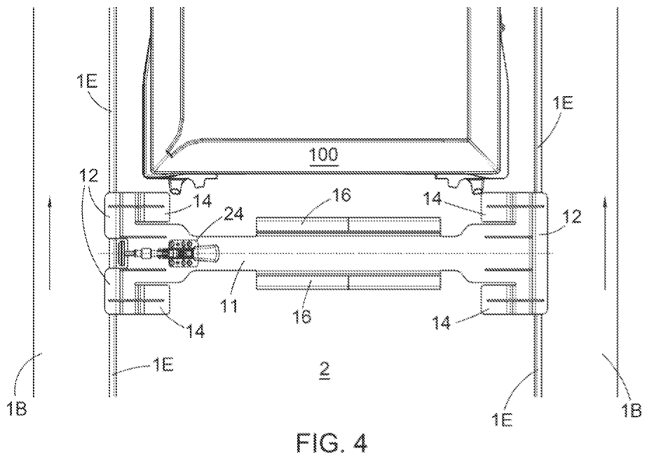

Between the two ends 10A 10B the restraint member 10 defines wing elements 15 that extend laterally from the longitudinal axis of the beam 11. Each wing 15 carries a bumper element 16 comprised from a resiliently flexible material. As seen best in FIG. 4, the upper flanges, and specifically the inwardly projecting flanges 14, lie laterally outward from the wings 15 relative to the longitudinal axis of the restraint member 10 (shown by the dashed line).

The restraint member 10 includes a toggle clamp 20 having a moveable jaw 21 mounted on a post 22, a multi-point lever mechanism 23 that includes a handle 23A, and a mount 24 on which the clamp 20 is seated on the beam 11. The moveable jaw 21 comprises a downwardly extending lip 21A that protrudes longitudinally outward from a primary outward facing clamping face 21B of the moveable jaw 21.

The mount 24 is coupled to the beam 11 through a connection that allows for linear movement of the clamp 20 relative to the beam 11 about the longitudinal axis of the restraint member 10. The connection may comprise, in one example, a spigot that protrudes downwardly from the base of the mount which is arranged to run within a slot formed in the beam 11. However, the form of the connection is unimportant.

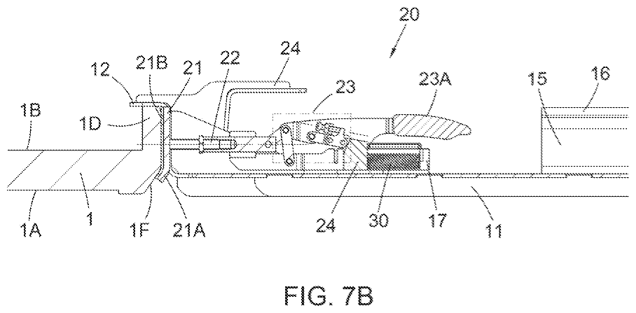

With reference to FIGS. 7A and 7B, arranged behind the clamp 20 and held between the mount 24 and a stay 17 of the beam 11 is a stiff bias spring 30 that provides, in conjunction with the moveable clamp 20, a self-adjustment function.

The clamp 20 is operable to move the moveable jaw 21 about the longitudinal axis of the restraint member 10 between a retracted position (FIG. 7A) in which the clamping face 21B of the moveable jaw 21 is co-planer or recessed with respect to the end face 11B of the second end 10B, and an extended position (FIG. 7B) in which the moveable jaw 21 protrudes outwardly beyond the end face 11B of the second end 10B.

Once the movable jaw 21 is homed in either the extended or retracted position, the multi-point lever mechanism 23 is adapted to retain the moveable jaw 21 in that position in absence of a force on the handle 23A.

The beam 11 is comprised from a rigid sheet material or casting e.g. a metal, which has been cut and bent to provide portions defining the upper flanges 12, 14, and stay 17. Alternatively, the features of the beam 11 may be formed by a casting process.

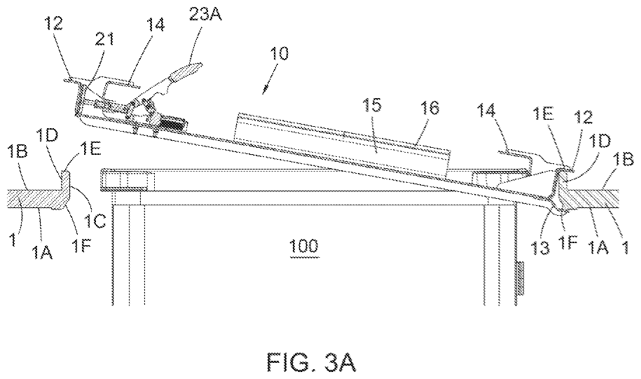

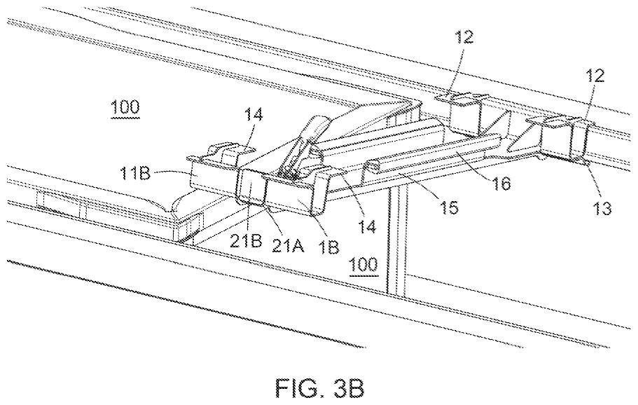

Referring to FIGS. 3A and 3B the restraint member 10 is shown being mounted in a walkway 2 between two parallel shelves 1 in a delivery van to contain movement of a cargo container 100 within the walkway in an axis extending parallel to the shelves 1 (perpendicular to the plane of the page in FIG. 3A).

Each shelf 1 comprises an underside 1A, an upper side 1B and an inwardly facing side 1C that faces the inward facing side of the other shelf 1. An inward free edge of each shelf provides an upwardly protruding lip 1D having an upper surface 1E. Formed at a junction between the inward facing side and the underside 1A is a chamfer 1F or similar undercut section.

With the moveable jaw 21 held in the retracted position the restraint member 10 is mounted across the shelves 1, at a position away from a cargo container 100 by lowering in from above at an attitude such that the outward extending flange 12 of the first end 10A seats on top of the upwardly protruding lip 1D of one shelf 1 before the second end 10B is pivoted downwardly until the outward flange 12 of the second end 10B seats on the upper face 1E of the upwardly protruding lip 1D of the opposite shelf 1.

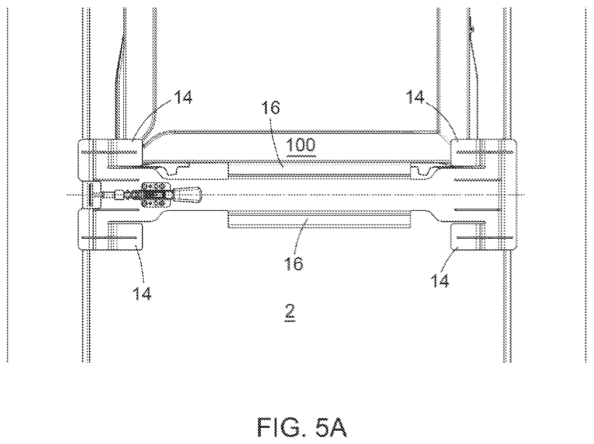

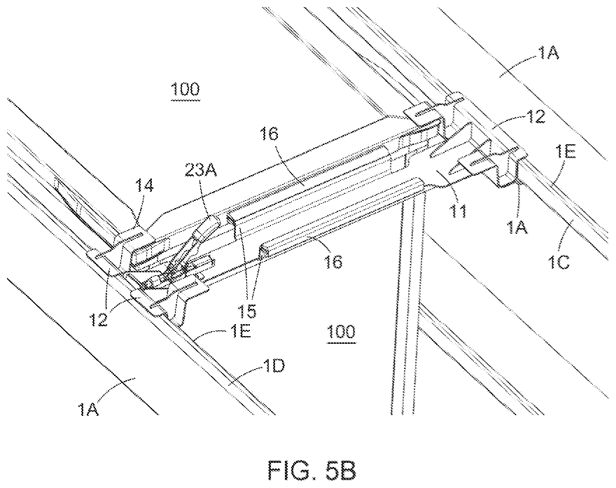

With reference to FIG. 4, the load restraint member 10 is then slid along the shelves 1, as indicated by the arrows, towards and against the cargo container 100, into the position illustrated in FIGS. 5A and 5B, such that the bumper element 6 on one side of the restraint member 10 contacts a side of the container 100 and the inward flanges 14 of the first and second ends 10A 10B of the same side lie directly above the container 100.

Once in position, the clamp 20 is actuated by depressing the handle to move the moveable jaw 21 to the extended position in which the clamping face 21B is pressed against the inside surface of the shelf. The member 10 is thus held in position by the reactionary inward force of the shelves 1 against the clamping face 21B and the end face of the restraint member 10.

In the engaged position the downwardly depending lip 21A of the moveable jaw 21 lies against the chamfer 1F and the lower flange 13 projects under the shelf 1 thereby inhibiting lifting either end 10A 10B of the restraint member 10 off the shelves 1.

Once held in position, contact of the bumper 16 against the container 100 acts to constrain movement of the container 100 towards the restraint member 10 and the flanges 14 act to constrain movement of the container 100 in a vertical axis.

Through the sliding connection, the clamp 20 is able to move relative to the beam 11 about the longitudinal axis against the spring 30 when actuated to move the moveable jaw 21 into the extended position. This provides means to compensate for any variation in the separation distance between the two inward facing sides 1C of the shelves 1 which could otherwise prevent the moveable jaw 21 from being homed, and thus retained by the multi-lever mechanism 23, in the extended position.

With reference to FIG. 5B, a possible problem with the afore described design is that when a second container 100 is brought up behind a restraint bar 10, which is already clamped onto the shelf to restrain a first container, the second container may strike against the projecting flanges 14 rather than passing under them. This would require unclamping the member 10 and lifting it up before moving the second container into position.

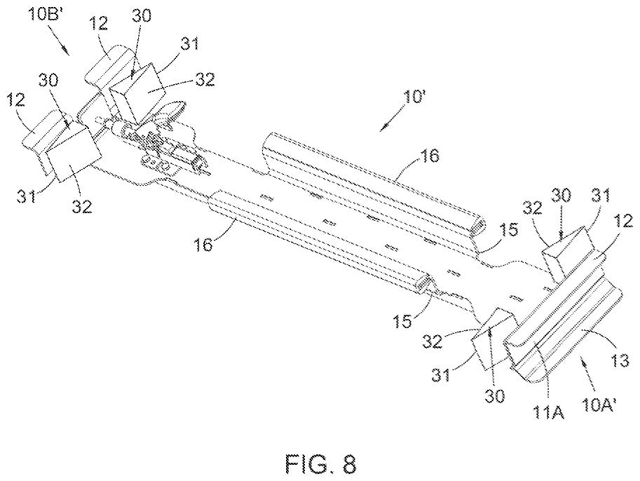

FIG. 8 illustrates a variant design of restraint member 10′ adapted to address this issue. The restraint member 10′ differs from that of the earlier embodiment only in the provision of pairs of guide members in the form of wedges 30 in place of the projecting flanges 14 at each end 10A 10B. The wedges 30 are arranged so that their narrow ends 31 face laterally outward. Each wedge 30 has an obliquely angled upwardly extending side 32 that faces longitudinally inwardly, i.e. towards the opposite end of the restraint member 10′.

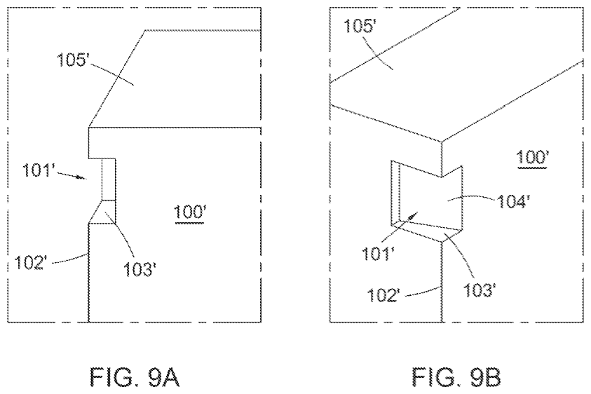

With reference to FIGS. 9A and 9B, each wedge 30 is arranged to be received within a separate recess 101′ provided at opposite sides of the container 100′. Each recess 101′ opens at a corner 102′ of the container 100′. Each recess comprises a lower wall 103′, and an upwardly extending wall 104′, the latter being angled obliquely such that the width of the recess 101′ narrows away from its opening at the corner 102′.

In operation, when the restraint member 10′ is slid along the shelves towards and against the cargo container 100′, the wedges 30 of the side of the member 10 that face towards the container 100, locate into corresponding recesses 101′, aligning the restraint member 10′ and/or container 100′. The tapered shape of the wedges 30 and recess 101′ minimize jamming as the restraint member 10′ is homed into position.

When located within their respective recesses, the wedges 30 sit directly above, and optionally against the lower wall 103′ of the recess which constrains movement of the container 100 in the vertical axis.

In a variation to this design the recess may open to the top face 105′ of the container; the guide members may take a form other than wedges; the recess 101′ may not be tapered.

A number of variations to the afore described example restraint members 10 10′ are described below.

The lower flange 13 may be angled to contact the chamfer 1F rather than extending under it. For restraint members 10 intended for use on supports 1 that have no chamfer 1F or equivalent undercut portion, the lip 21A may be arranged to extend under the support 1 to face under surface 1A.

The second end 10B may also be provided with a lower flange that projects longitudinally outwards beyond the end face 11B of the second end 10B in order to engage with the under surface 1A of the shelf 1. Where so, the lip 21A of the jaw 21 may be omitted.

The wing elements 15 are a convenient means of providing laterally extending elements to engage the container 100 where the beam 11 is formed from sheet material. Nevertheless, and partially where the restraint member 10 is constructed in other ways, the wing elements 15 may be omitted and the bumper elements 16, where included implemented by other means.

The restraint member 10 could comprise a clamp 20 at both ends 10A 10B to clamp 20 against both shelves 1 though this is less preferred as it would not be expected to provide any advantage in simplicity or speed of mounting.

The beam 11 may be designed without an end face 11B at the second end 10B that lies against the inward side 1C of the shelf. Instead contact with the support 1 may be solely through the clamping face 21B of the clamp 20. Where the first end 10A of the restraint member 10 is provided with a clamp 20 the same may apply.

The use of a toggle clamp 20 is convenient as it enables the moveable jaw to be quickly translated between the extended and withdrawn positions with a single movement. Nevertheless, other types and forms of clamp 20 may be used instead.

Although described in relation to shelves 1, the restraint member 10 is equally adapt for fitting against parallel rails or other elongate supporting members that have parallel upper and inward facing surfaces.

The Abstract is provided with the understanding that it is not intended be used to interpret or limit the scope or meaning of the claims. In addition, in the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

Although specific embodiments of the subject matter have been disclosed, those having ordinary skill in the art will understand that changes can be made to the specific embodiments without departing from the scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. A system comprising:
a pair of elongate supports extending parallel about opposite sides of a deck of a vehicle to constrain movement of cargo placed on the deck between the supports in a horizontal plane;
each support having an upward facing surface and an inward facing surface, the inward facing surfaces orientated face-to-face across the deck; and
a rigid elongate load restraint member that extends between and is secured to the supports to constrain movement of cargo placed on the deck between the supports,
the restraint member comprising:
an end face about each end of the restraint member that faces the inward facing surface of its respective elongate support;
a projection that protrudes longitudinally beyond each end face and upon which the restraint member seats on and can slide along the upward facing surfaces of the elongate supports to position the restraint member against the cargo; and
a clamp having a jaw that defines, at least in part, one of the end faces; the clamp operable to move the jaw about a longitudinal axis of the restraint member to press the end faces against the inward facing surfaces of the support to secure the restraint member in position against the elongate supports.

2. A system according to claim 1 wherein the cargo comprises an intermodal container.

3. A system according to claim 1 wherein the restraint member comprises one or more projections that, when the restraint member is positioned against the cargo, constrain movement of the cargo about a vertical axis.

4. A system according to claim 1, wherein the cargo comprises an intermodal container, and wherein the intermodal container comprises a recess and that projection is arranged, when the restraint member is positioned against the cargo, to protrude into the recess to constrain movement of the cargo about a vertical axis.

5. A system according to claim 1 wherein the restraint member comprises projections that, when the restraint member is seated against the cargo, extend directly above the cargo to constrain movement of the cargo about a vertical axis.

6. A system according to claim 1 wherein the restraint member comprises a beam, and a spring, the clamp is mounted to the beam about a connection that allows the clamp to move relative to the beam about the longitudinal axis of the restraint member against the spring when the clamp is actuated to press the jaw against the support.

7. A system according to claim 1 wherein the restraint member comprises a further projection that protrudes longitudinally beyond each end face and offset from the end face so as to lie directly underneath the support to mechanically constrain the load in a vertical plane.

8. A system according to claim 7 wherein at least one of the further projections is provided by a lip of the jaw of the clamp.

9. (canceled)

10. A system for restraining intermodular cargo being transported in a hold of a vehicle, the system comprising:
a pair of shelves extending parallel about opposite sides of a deck of a vehicle to constrain movement of cargo placed on the deck between the shelves in a horizontal plane; each shelf in the pair having an upward facing surface and an inward facing surface, the inward facing surfaces of the pair of shelves orientated face-to-face across the deck; and
a rigid load restraint bar that extends between and is secured to the pair of shelves to constrain movement of cargo placed on the deck between the pair of shelves,
the rigid load restraint bar comprising:
an end face about each end of the rigid load restraint bar that faces the inward facing surface of its respective shelf in the pair of shelves;
a projection that protrudes longitudinally beyond each end face and upon which the rigid load restraint bar seats on and can slide along the upward facing surfaces of the pair of shelves to position the rigid load restraint bar against the cargo; and
a clamp having a jaw that defines, at least in part, one of the end faces; the clamp operable to move the jaw about a longitudinal axis of the rigid load restraint bar to press the end faces against the inward facing surfaces of the pair of shelves to secure the rigid load restraint bar in position against the pair of shelves.

11. A system for restraining intermodular cargo being transported in a hold of a vehicle, the system comprising:
a rigid load restraint bar that extends between and is secured to a pair of shelves extending parallel about opposite sides of a deck in a hold of a vehicle, to constrain movement of cargo placed on the deck between the pair of shelves, each shelf in the pair of shelves having an upward facing surface and an inward facing surface, the inward facing surfaces of the pair of shelves orientated face-to-face across the deck;
the rigid load restraint bar comprising:
an end face about each end of the rigid load restraint bar that faces the inward facing surface of its respective shelf in the pair of shelves;
a projection that protrudes longitudinally beyond each end face and upon which the rigid load restraint bar seats on and can slide along the upward facing surfaces of the pair of shelves to position the rigid load restraint bar against the cargo; and
a clamp having a jaw that defines, at least in part, one of the end faces; the clamp operable to move the jaw about a longitudinal axis of the rigid load restraint bar to press the end faces against the inward facing surfaces of the pair of shelves to secure the rigid load restraint bar in position against the pair of shelves.

12. The system of claim 11, wherein the rigid load restraint bar comprises one or more projections that, when the rigid load restraint bar is positioned against cargo on the deck, constrain movement of the cargo about a vertical axis.

13. The system of claim 12, wherein the cargo comprises an intermodal container, and wherein the intermodal container comprises a recess and that a projection of the one or more projections is arranged, when the rigid load restraint bar is positioned against the cargo, to protrude into the recess to constrain movement of the cargo about a vertical axis.

14. The system of claim 11, wherein the rigid load restraint bar comprises projections that, when the rigid load restraint bar is seated against the cargo, extend directly above the cargo to constrain movement of the cargo about a vertical axis.
